(19) United States
(12) Patent Application Publication
(10) Pub. No.: US 2001/0056538 A1
(43) Pub. Date: Dec. 27, 2001

(54) Information processing apparatus for adding sender information to transmission data and transmitting the transmission data and control method therefor

(76) Inventor: Hiroyuki Amano, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/879,183

(22) Filed: Jun. 13, 2001

(30) Foreign Application Priority Data
Jun. 19, 2000 (JP) 183103/2000

(51) Int. Cl. H04L 9/00; H04N 1/44

(52) U.S. Cl. 713/185; 380/243

(57) ABSTRACT

An information processing apparatus that imposes a restriction on the use of a shared communication apparatus such as a facsimile machine, thereby preventing a person from posing as a different person when transmitting data such as a document. User authentication is performed, and transmission data is transmitted in accordance with the authentication result. Information such as a sender name, which corresponds to the information specifying a user used to perform the user authentication, is added to the transmission data.

### BACKGROUND OF THE INVENTION

1. Field of the Invention

The present invention relates to information processing apparatuses, management devices, control methods therefor, and storage media for storing the control methods.

2. Description of the Related Art

Systems which share a facsimile machine (fax) on a network on which a plurality of information processing apparatuses such as personal computers are connected are known.

In these systems, a fax driver for using the facsimile machine is installed in each information processing apparatus. The fax driver is activated, and thereafter a transmission instruction is given to the facsimile machine.

A plurality of types of a cover page to be attached to an image transmitted during facsimile transmission can be registered in the fax driver installed in each information processing apparatus. A sender activates the fax driver and selects a cover page, and the selected cover page is automatically attached to the top page of the image to be transmitted. The image is thereafter transmitted.

No restriction is imposed on the use of the facsimile machine. Hence, anybody can freely use the facsimile machine on the network.

Cover pages which include the name of a company and the name of a department in the company are registered in the fax driver. Although a person who receives a facsimile can get a rough idea about who has sent the facsimile, the receiver of the facsimile cannot determine who has sent the facsimile.

It is possible to register a cover page which includes a signature of each person. However, when a cover page is registered for each person, the number of cover pages increases, it becomes cumbersome for a sender to select a cover page, and numerous mistakes in selecting a cover page will be made.

Since anybody can select any cover page from among registered cover pages, a person can select a cover page so that the person can pose as a different person when sending a facsimile. Although the facsimile includes a cover page to which the signature of a sender is attached, a receiver of the facsimile cannot determine whether the facsimile is signed by the actual sender, i.e., whether the cover page is attached to the facsimile by the actual sender. Under these circumstances, the security of facsimile transmission is uncertain.

### SUMMARY OF THE INVENTION

According to an aspect of the present invention, an information processing apparatus is provided having an authentication means and a transmitting means. The authentication means authenticates information which specifies a user of the information processing apparatus. The transmitting means automatically adds sender information which corresponds to the user-specifying information to transmission data and transmits the transmission data.

According to another aspect of the present invention, an information processing apparatus is provided having a storing means for storing second information corresponding to first information specifying the user of another information processing apparatus, a receiving means for receiving the first information and transmission data transmitted from the other information processing apparatus, and a transmitting means for adding the second information to the transmission data and transmitting the transmission data.

According to a further aspect of the present invention, an information processing apparatus is provided having a determining means for determining whether a user of the information processing apparatus is authorized to transmit data using a communication apparatus connected to the information processing apparatus, and a transmitting means for transmitting the data to the communication apparatus in accordance with the determination by the determining means.

According to yet another aspect of the present invention, a control method for an information processing apparatus is provided including the steps of performing authentication using information that specifies a user of the information processing apparatus, and automatically adding the user-specifying information to transmission data and transmitting the transmission data.

According to still another aspect of the present invention, a control method for an information processing apparatus is provided including the steps of storing second information corresponding to first information which specifies a user of another information processing apparatus, and adding, when the first information and transmission data are received from the other information processing apparatus, the second information to the transmission data and transmitting the transmission data.

According to another aspect of the present invention, a control method is provided including the steps of determining whether a user of an information processing apparatus is authorized to transmit data using a communication apparatus connected thereto, and transmitting the data to the communication apparatus in accordance with the determination obtained in the determining step.

According to yet another aspect of the present invention, a storage medium is provided having recorded thereon a computer-readable program for performing the steps of authenticating information which specifies a user of an information processing apparatus, and automatically adding sender information corresponding to the user-specifying information to transmission data and transmitting the transmission data.

According to still another aspect of the present invention, a storage medium is provided having recorded thereon a computer-readable program for performing the steps of storing second information corresponding to first information which specifies a user of another information processing apparatus, receiving the first information and transmission data transmitted from the other information processing apparatus, and adding the second information to the transmission data and transmitting the transmission data.

According to yet a further aspect of the present invention, a storage medium is provided having recorded thereon a computer-readable program for performing the steps of determining whether a user of an information processing apparatus is authorized to transmit data using a communication apparatus connected to the information processing apparatus, and transmitting the data to the communication apparatus in accordance with the determination obtained in the determining step.

Further objects, features, and advantages of the present invention will become apparent from the following description of the preferred embodiments with reference to the attached drawings.

### BRIEF DESCRIPTION OF THE DRAWINGS

FIG. 1 is a block diagram of an information processing apparatus according to first to third embodiments of the present invention;

FIG. 2 illustrates registered contents of a floppy disk (FD) or a compact disk-read only memory (CD-ROM);

FIG. 3 illustrates the relationship between the FD/CD-ROM and the information processing apparatus;

FIG. 4 illustrates a memory map in the information processing apparatus when a fax driver is installed in a hard disk (HD) of the information processing apparatus;

FIG. 5 illustrates the configuration of a network of the first to third and sixth embodiments of the present invention;

FIG. 6 is a flowchart showing a user registration and cover-page registration process in the first embodiment;

FIG. 7 is a conceptual diagram of registration of user names, passwords, and sender names in the first embodiment;

FIG. 8 is a flowchart showing a facsimile transmission process in the first embodiment;

FIG. 9 is a flowchart showing a facsimile transmission process in the second embodiment;

FIG. 10 is a flowchart showing a user registration and cover-page registration process in the third embodiment;

FIG. 11 is a conceptual diagram of registration of user names, passwords, and sender names in the third embodiment;

FIG. 12 is a conceptual diagram of registration of cover pages and authorized users of each cover page in the third embodiment;

FIG. 13 is a flowchart showing a facsimile transmission process in the third embodiment;

FIG. 14 illustrates the configuration of a network of the fourth to seventh embodiments;

FIG. 15 is a flowchart showing a process of installing a fax driver of the fourth embodiment;

FIG. 16 is a conceptual diagram of registration of user names, passwords, sender names, cover pages, and address books in the fourth embodiment;

FIG. 17 is a flowchart showing a facsimile transmission process performed by an information processing apparatus of the fourth embodiment;

FIG. 18 is a flowchart showing a process of installing a fax driver of the fifth embodiment;

FIG. 19 is a flowchart showing a facsimile transmission process performed by an information processing apparatus of the fifth embodiment;

FIG. 20 is a flowchart showing a facsimile transmission process performed by a fax server of the fifth embodiment;

FIG. 21 is a flowchart showing a process of installing a fax driver of the sixth embodiment;

FIG. 22 is a flowchart showing a facsimile transmission process performed by an information processing apparatus of the seventh embodiment;

FIG. 23 illustrates a registered cover page of the first to seventh embodiments;

FIG. 24 is a block diagram of the information processing apparatus of the fourth to seventh embodiments;

FIG. 25 is a block diagram of the fax server of the fourth to seventh embodiments; and

FIG. 26 is a flowchart showing a facsimile transmission process in the seventh embodiment.

### DESCRIPTION OF THE PREFERRED EMBODIMENTS

First Embodiment

An information processing apparatus according to a first embodiment of the present invention will now be described.

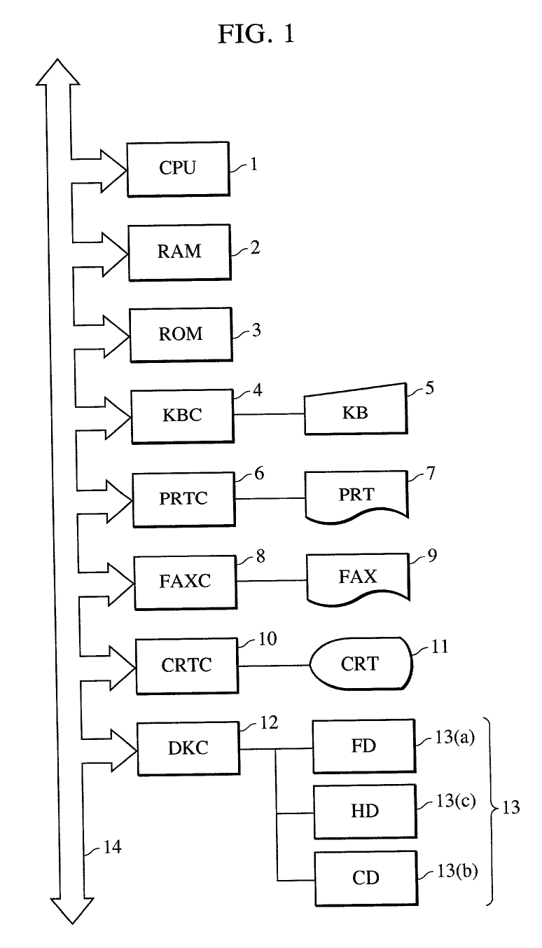

FIG. 1 shows the basic structure of the information processing apparatus of the first embodiment.

Referring to FIG. 1, a central processing unit (CPU) 1 controls the overall information processing apparatus and performs arithmetic processing. A program and data for each process are loaded into a random access memory (RAM) 2, and the loaded program is executed in the RAM 2. A read only memory (ROM) 3 is a storage area for storing a system control program, font data, and the like. A keyboard controller (KBC) 4 receives data in response to key inputs from a keyboard (KB) 5 and transfers the data to the CPU 1. A printer controller (PRTC) 6 controls a printer device (PRT) 7. The printer device (PRT) 7 includes a laser beam printer or an ink-jet printer. A facsimile controller (FAXC) controls a facsimile machine (FAX) 9. The facsimile machine is connected to the information processing apparatus via a network.

A display controller (CRTC) 10 controls the display of a display device (CRT) 11. A disk controller (DKC) 12 controls data transmission or the like. An external storage device 13 such as a floppy disk 13(a) (FD), a hard disk 13(c) (HD), or a CD-ROM 13(b) (CD) stores programs and data. If required, the programs and the data are referred to or loaded into the RAM 2 when executing the programs. A system bus 14 is a data transmission path among the above-described components.

The information processing apparatus is operated by the CPU 1 which executes a basic input/output (I/O) program, an operating system (OS), and a fax driver program which includes a fax security control function which will be described below.

The basic I/O program is stored in the ROM 3. The OS is written in the HD 13(c). When power is supplied to the information processing apparatus, the OS is read from the HD 13(c) to the RAM 2 by an initial program loading (IPL) function in the basic I/O program, and the OS starts operating.

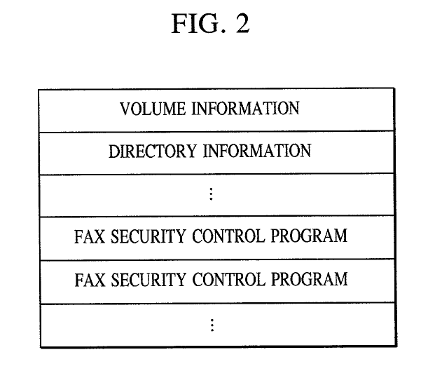

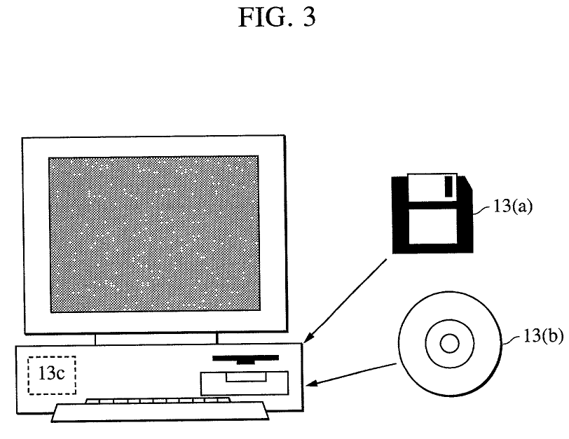

Referring to FIG. 2, the fax driver program which includes the fax security control function and related data are recorded in the FD 13(a) or in the CD-ROM 13(b) in the first embodiment. Referring to FIG. 3, the fax driver program which includes the fax security control function and the related data are installed in the HD 13(c) of the information processing apparatus through an FD drive or a CD-ROM drive. In this case, when the FD 13(a) or the CD-ROM 13(b) is set in the FD drive or the CD-ROM drive, respectively, the fax driver program and the related data are read from the FD 13(a) or the CD-ROM 13(b) under the control of the OS and the basic I/O program. The read program and the data are installed in the HD 13(c), and hence the information processing apparatus starts operating.

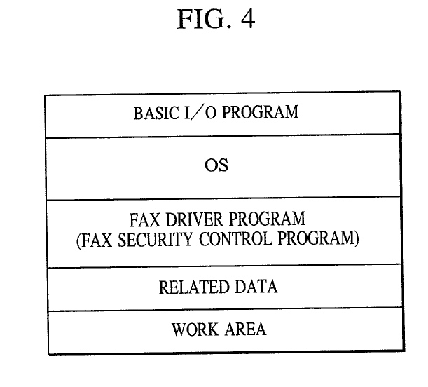

FIG. 4 shows a memory map when the fax driver program which includes the fax security control function is installed in the HD 13(c) and is thus executable.

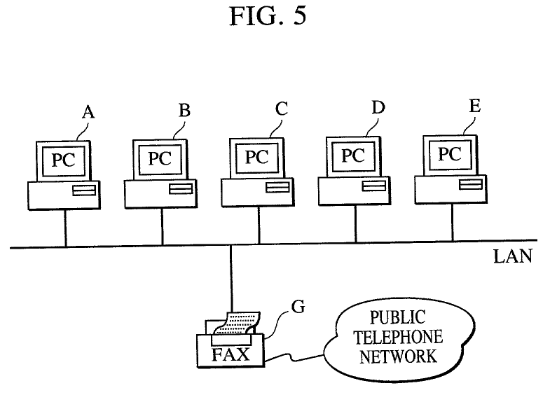

FIG. 5 illustrates an example of a network system of the first embodiment. As shown in FIG. 5, information processing apparatuses A to E are connected to a local area network (LAN), and a facsimile machine (FAX) G is shared by the information processing apparatuses A to E.

When using the facsimile machine G, the fax driver installed in the information processing apparatus is activated, and the fax driver gives a transmission instruction to the facsimile machine G. As a result, a facsimile can be transmitted through a public telephone network.

In the first embodiment, one information processing apparatus can be shared by a plurality of users. Every time the fax driver installed in each information processing apparatus is activated, user authentication is performed to verify the user. The sender name registered by the authenticated user is written on a cover page, and the cover page is added to the top page of a transmission image created by the information processing apparatus, and the image is transmitted.

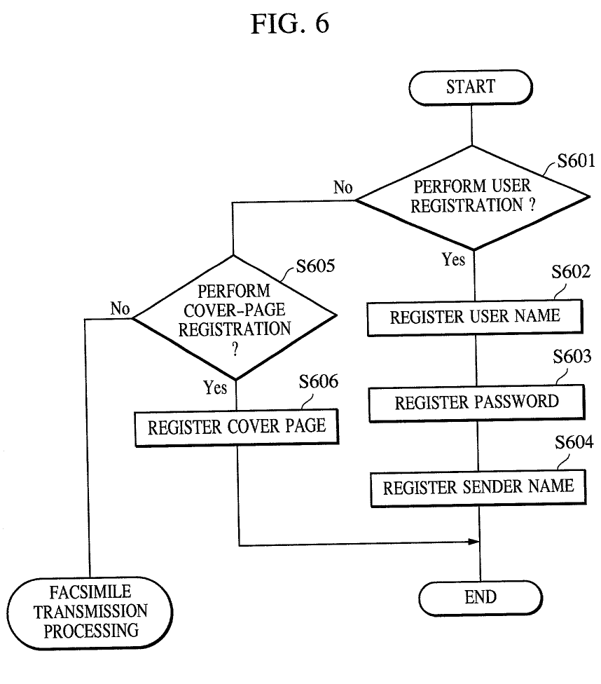

FIG. 6 is a flowchart showing a user registration and cover-page registration process of the first embodiment. Hereinafter it is assumed that the CPU 1 reads a program stored in the HD 13(c) and executes the program.

Referring to FIG. 6, a user of the information processing apparatus operates the KB 5 to activate the fax driver, and the CPU 1 activates the fax driver installed in the HD 13(c). When the fax driver is activated, in step 601 and/or step S605, the process selects user registration or cover-page registration. When the user registration is selected, in step S602, the process registers a user name in order to authenticate the user who is using the information processing apparatus. In step S603, the process registers a password.

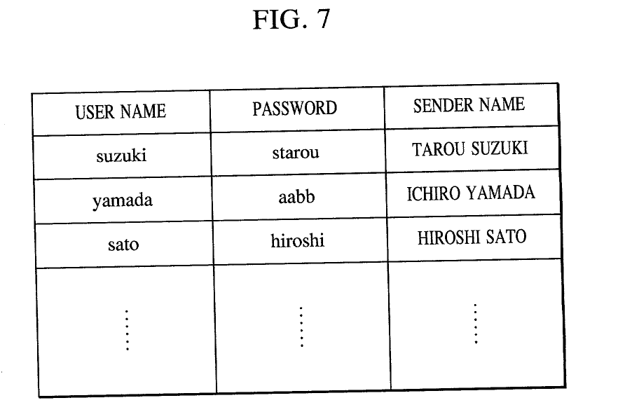

In step S604, the process registers a sender name to be written on a cover page. As shown in FIG. 7, the registered user name, password, and sender name are registered in the fax driver in the information processing apparatus.

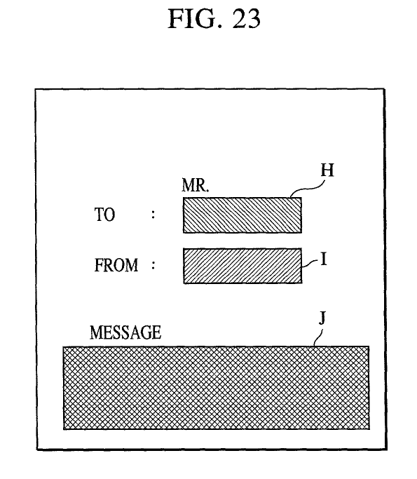

When the cover-page registration is selected in step S604, the process registers a cover page created by the information processing apparatus. When the user creates a cover page to be registered, it is necessary to specify, as shown in FIG. 23, a destination region H in which the user inputs a destination name for every facsimile transmission, a sender name region I in which the sender name registered in step S604 is automatically written by the fax driver, a transmission message region J in which the user inputs a transmission message for every facsimile transmission, and the like. In the first embodiment, the destination region H and the transmission message region J are not mandatory, whereas the sender name must be specified in the sender name region I.

When the cover-page registration is not selected in step S605, it is determined that the fax driver for performing facsimile transmission is activated. Thus, facsimile transmission processing, which will be described hereinafter, is performed.

Although it is shown in FIG. 6 that the user registration is performed when the fax driver is activated, the user registration can be performed when the fax driver is installed.

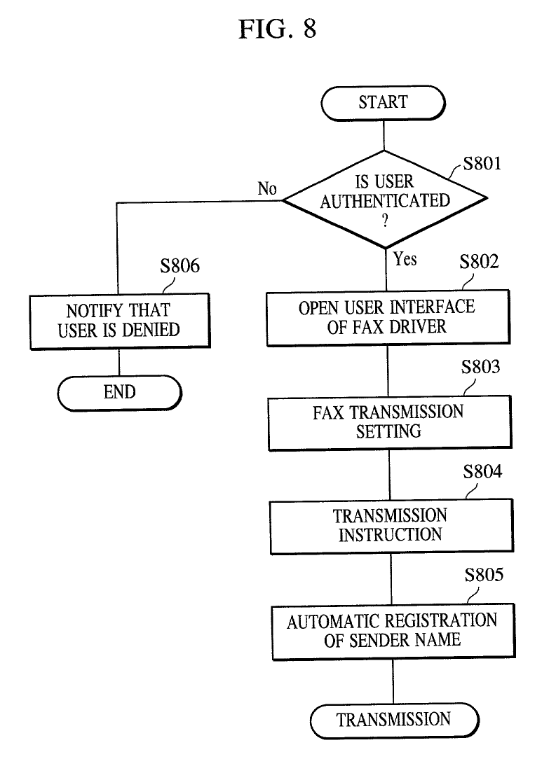

FIG. 8 is a flowchart showing a facsimile transmission process performed by the CPU 1 of the information processing apparatus of the first embodiment in accordance with the program stored in the HD 13(c).

Referring to FIG. 8, when a facsimile machine is specified as a device for outputting text (a document) created by the user of the information processing apparatus, the fax driver is activated. When the fax driver is activated, in step S801, the fax driver requests authentication of the user for using the fax driver. The eligible user name and password are the user name and the password which are registered by the process shown in FIG. 6. User authentication is performed by checking the user name and password input to the information processing apparatus with the user name and password registered in the fax driver. Alternatively, the user name and password can be automatically registered by the fax driver using a log-on name for the information processing apparatus and a password therefor, or a user name for establishing a network connection and a password therefor. In these cases, in step S803 or the like, it is necessary to register, at least one time, the sender name corresponding to the user name and the password. The password can be changed after the user is authenticated.

When the input user name and password do not match the user name and password registered in the fax driver, in step S806, the user is notified that the user cannot use the fax driver, and the process is terminated.

When the input user name and password match the registered user name and password, in step S802, the process opens a user interface of the fax driver.

The user interface displays the cover page registered by the process shown in FIG. 6 and cover pages which are registered in advance in the fax driver, and the user can select one from among the cover pages.

In step S803, the user selects a cover page, sets a destination phone number, and inputs data in the destination region H and the transmission message region J.

In step S804, the process sends a transmission instruction to transmit the document. In step S805, the process writes the sender name which corresponds to the user name used in the user authentication in the sender name region I of the selected cover page. The cover page is added to the top page of the document, and the document and information such as the destination phone number are transmitted to the facsimile machine G.

It is also possible to write the sender name not only on the cover page but also at a specific place on each page of the document. In this case, in step S803, the process sets whether the sender name is written only on the cover page or on each page of the document. When the sender name is written on each page of the document, the process sets a region (header or footer) of the document to write the sender name.

The facsimile machine G makes a call to the phone number received at the same time as the document to which the cover page is added, and transmits the received document through the public telephone network.

As described above, according to the first embodiment, the sender name is determined by the user authentication performed when the fax driver is activated. It is thus possible to prevent a person from using another person's signature when transmitting a facsimile.

Second Embodiment

In a second embodiment, user authentication is performed after a facsimile transmission instruction is given. Since the structure of an information processing apparatus and the configuration of a network used in the second embodiment are similar to those in the first embodiment, detailed descriptions of common portions are omitted.

A user registration and cover-page registration process is similar to that of the first embodiment.

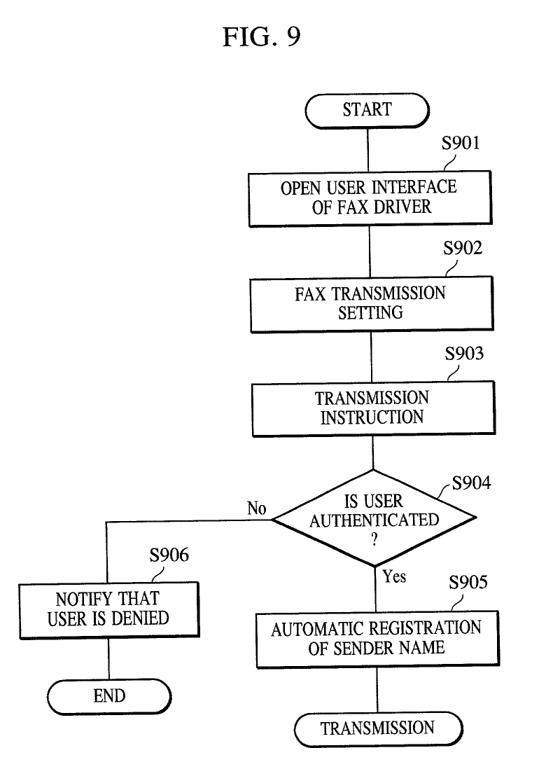

FIG. 9 is a flowchart showing a facsimile transmission process performed by a CPU 1 of the information processing apparatus of the second embodiment in accordance with a program stored in an HD 13(c).

Referring to FIG. 9, when a facsimile machine is specified as a device for outputting text (a document) created by the information processing apparatus, the CPU 1 activates a fax driver. When the fax driver is activated, in step S901, the process opens a user interface in order to select a cover page and to perform setting such as specifying of a destination phone number.

In step S902, facsimile transmission settings such as the selection of a cover page, specifying of a destination phone number, inputting of information to a destination region H and a transmission message region J shown in FIG. 23 are performed. In step S903, the process gives a facsimile transmission instruction. In step S904, user authentication for the information processing apparatus begins.

The eligible user name and password for the authentication are the user name and password registered by the process shown in FIG. 6 in the first embodiment. User authentication is performed by checking the user name and password input to the information processing apparatus with the user name and password registered in the fax driver. Alternatively, the user name and password can be registered using a log-on name for the information processing apparatus and a password therefor or a user name for establishing a network connection and a password therefor. In these cases, it is necessary to register, at least one time, the sender name which corresponds to the user name and the password. The password can be changed after the user is authenticated.

In step S904, the process determines whether the input user name and password match the user name and password registered in the fax driver. If the determination is negative, the process notifies the user that the user is not allowed to transmit a facsimile. If the determination is affirmative, in step S905, the process automatically writes the sender name which corresponds to the user name used in the user authentication in a sender name region I of the cover page. The cover page is added to the top page of the document, and the cover page and information such as the destination phone number are transmitted to a facsimile machine G.

The facsimile machine G makes a call to the phone number received at the same time as the document to which the cover page is added, and transmits the received document through a public telephone network.

As in the first embodiment, the sender name can be written not only on the cover page but also at a specified place on each page of the document. In this case, in step S902, the process sets whether the sender name is written only on the cover page or on each page of the document. If it is determined that the sender name is written on each page of the document, the process sets a region (header or footer) of the document to write the sender name.

As described above, according to the second embodiment, the cover page and the sender name written on the document are determined by the authentication performed in facsimile transmission. It is thus possible to prevent a person from using another person's signature when transmitting a facsimile.

Third Embodiment

In a third embodiment, a restriction is imposed on a user who is authorized to use a cover page registered by a user. For example, when a person in ABC section, CD department creates a cover page, the characters “ABC section, CD department” are inserted near a sender name region I in which the name of a sender of a cover page is automatically written, and the cover page is registered. Only people who belong to ABC section, CD department are allowed to use the cover page. In this way, it is only necessary to register the names of people who belong to ABC section, CD department in order to automatically write the sender name. It is also possible to prevent people in another section from using the cover page with the characters “ABC section, CD department” without permission.

The operation in the third embodiment will now be described in detail. Since the structure of an information processing apparatus and the configuration of a network used in the third embodiment are similar to those in the first and second embodiments, detailed descriptions of common portions are omitted.

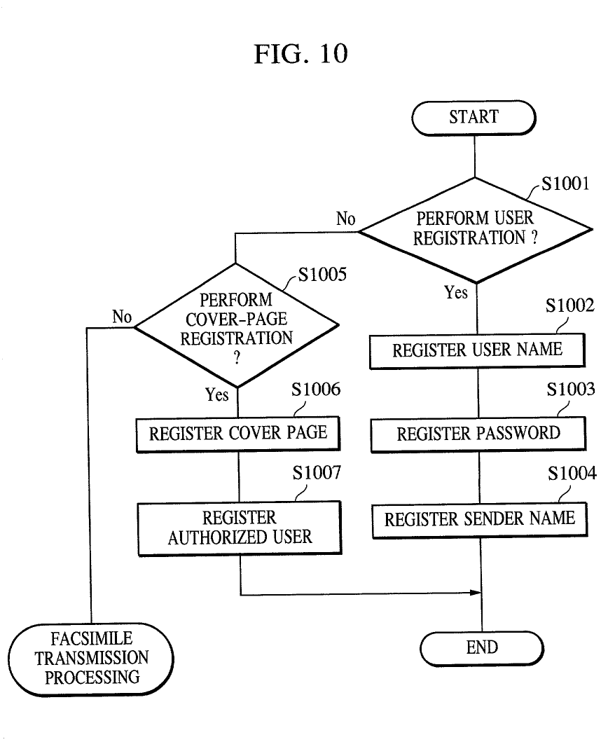

FIG. 10 is a flowchart showing a user registration and cover-page registration process performed by a CPU 1 of the information processing apparatus of the third embodiment in accordance with a program stored in an HD 13(c).

Referring to FIG. 10, when a fax driver is activated by a user of the information processing apparatus, in step S1001 and/or step S1005, the process selects user registration or cover-page registration. If the user registration is selected, in step S1002, the process registers a user name in order to perform user authentication for the information processing apparatus. In step S1003, the process registers a password.

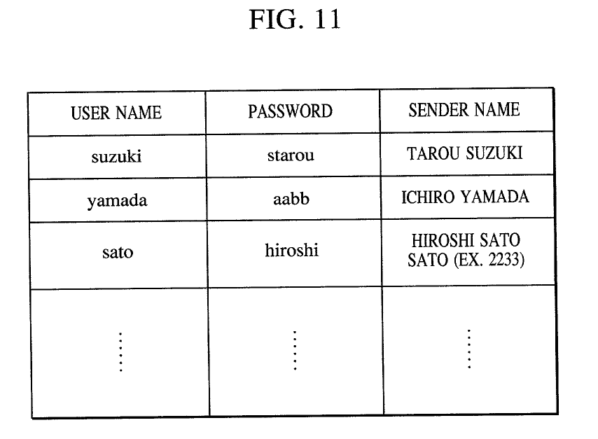

In step S1004, the process registers a sender name to be written on a cover page. In the third embodiment, a plurality of sender names can be registered under a single user name. When a plurality of sender names are registered, the sender name to be used is selected when a facsimile transmission is performed. As shown in FIG. 11, the registered user name, password, and sender name are registered and managed by the fax driver of the information processing apparatus.

When the cover-page registration is selected in step S1005, the process registers a cover page (FIG. 23) created by the information processing apparatus. In step S1007, the process registers the name of a user who is authorized to use the cover page. If no user name of a user who can use the cover page is registered, all users can use the cover page.

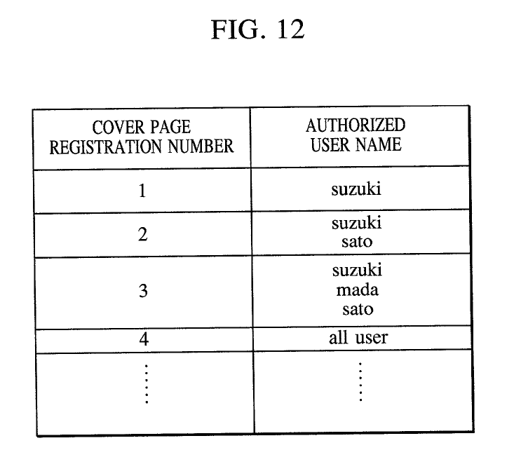

As shown in FIG. 12, a cover page number is assigned to each of the registered cover pages and cover pages which are registered in advance in the fax driver, and the user name of a user who is authorized to use each cover page is registered in the fax driver.

When the cover-page registration is not selected in step S1005, the process performs facsimile transmission processing described below.

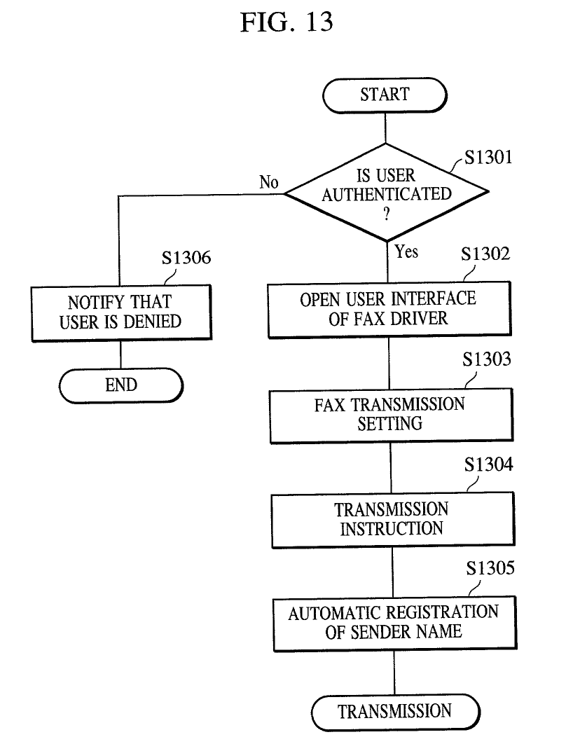

FIG. 13 is a flowchart showing a facsimile transmission process performed by the CPU 1 of the information processing apparatus of the third embodiment in accordance with the program stored in the HD 13(c).

Referring to FIG. 13, when a facsimile machine is specified as a device for outputting text (a document) created by the user of the information processing apparatus, the CPU 1 activates the fax driver. When the fax driver is activated, in step S1301, the fax driver requests user authentication for the use of the fax driver. The eligible user name and password are the user name and the password which are registered by the process shown in FIG. 10. Alternatively, the user name and the password can be automatically registered by the fax driver using a log-on name for the information processing apparatus and a password therefor, or a user name for establishing a network connection and a password therefor. Also, the password can be changed after the user is authenticated.

When the user name and password input to the information processing apparatus do not match the user name and password registered in the fax driver in step S1301, the process notifies, in step S1306, the user that the user is not allowed to use the fax driver, and the process is terminated.

When the input user name and password match the registered user name and password, that is, when the user is authenticated, the process opens a user interface of the fax driver in step S1302.

The user interface displays only cover pages which can be used by the user whose user name is used in the user authentication, and the user can select a cover page.

When a plurality of sender names is registered under a single user name, the process displays the sender names which can be used under that user name, and the user can select one from among the sender names.

In step S1303, the process selects a cover page which can be used under the authenticated user name. When a plurality of sender names is registered under that user name, the process selects a sender name to be used. Also, the process sets a destination phone number and inputs data to a destination region H and a transmission message region J.

When the process gives a transmission instruction to transmit the document in step S1304, the process automatically writes the selected sender name in the sender name region I of the selected cover page. The cover page is added to the top page of the document, and the cover page and information such as the destination phone number are transmitted to a facsimile machine G.

The facsimile machine G makes a call to the received phone number and transmits the received document. The cover page is added to the transmitted document.

Alternatively, the sender name can be written not only on the cover page but also at a specified place on each page of the document. In this case, in step S1303, the process sets whether the sender name is written only on the cover page or on each page of the document. If the process determines to write the sender name on each page of the document, the process sets a region (header or footer) of the document to write the sender name.

As described above, according to the third embodiment, it is possible to restrict a user who can use a particular cover page. For example, it is possible to prevent a person from using a cover page in which the name of a section to which another person belongs is written.

Fourth Embodiment

In a fourth embodiment, an example of a system is described in which setting items required for facsimile transmission are registered and stored respectively for each user in a server. When transmitting a facsimile, a connection with the server is established, and hence it is possible to refer to and use data in the server.

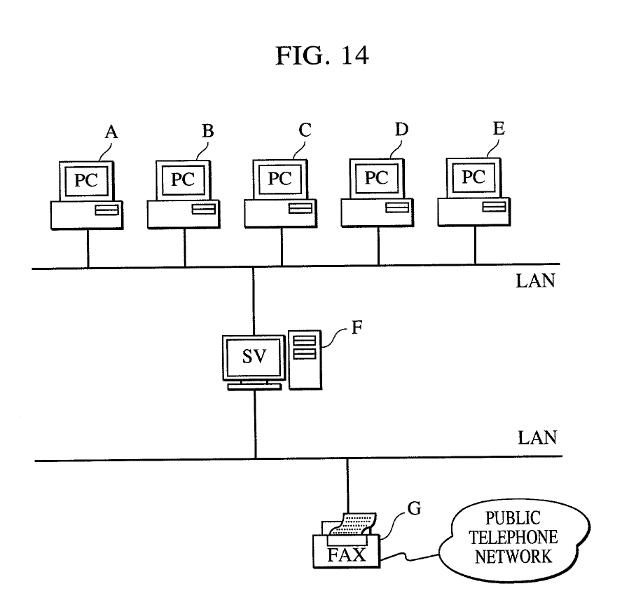

FIG. 14 shows the configuration of a network of the fourth embodiment. Referring to FIG. 14, the network includes information processing apparatuses A to E such as personal computers and a server F (hereinafter referred to as a fax server F) which manages a facsimile machine G. The facsimile machine G is connected to a LAN or a public telephone network.

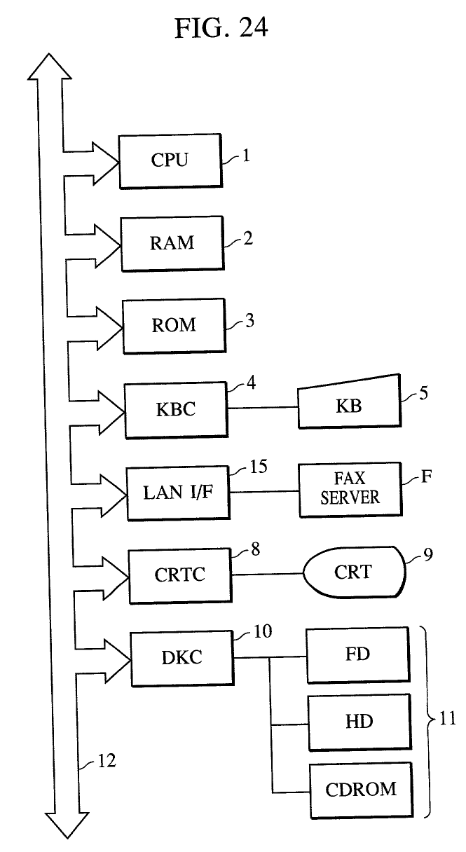

FIG. 24 shows the structure of an information processing apparatus of the fourth embodiment.

Referring to FIG. 24, the information processing apparatus of the fourth embodiment uses a local area network interface (LAN I/F) 15 in place of the fax controller (FAXC) 8 shown in FIG. 1. The information processing apparatus establishes a connection with the fax server F through the LAN I/F 15. In FIG. 1, the LAN I/F 15 is omitted. Since the remaining structure is similar to that shown in FIG. 1, detailed descriptions of common portions are omitted.

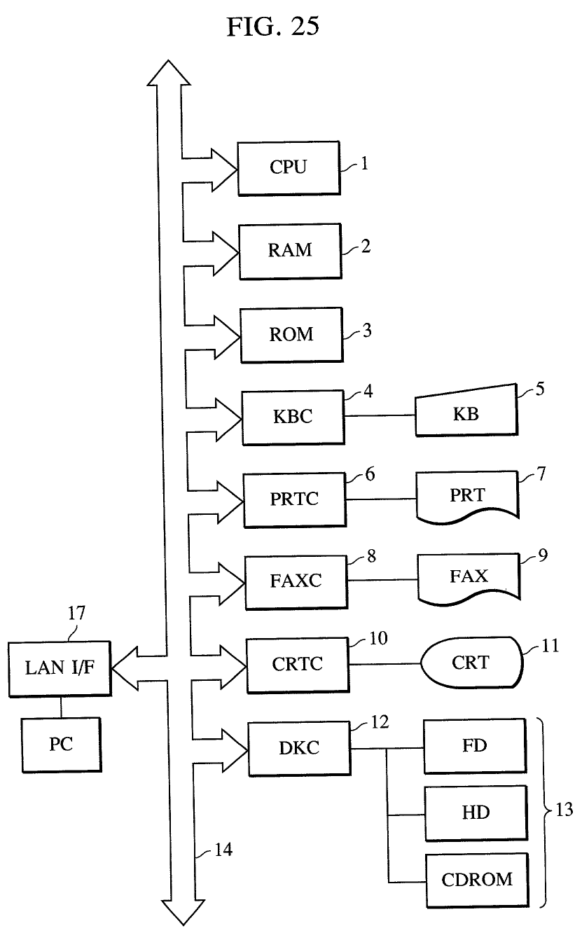

FIG. 25 shows the structure of the fax server F.

Referring to FIG. 25, the fax server F includes a fax controller (FAXC) 8 which is similar to that shown in FIG. 1, which is connected to a facsimile machine (FAX) 9. The fax server F includes a LAN I/F 17 and establishes a connection with an information processing apparatus (PC) through the LAN I/F 17.

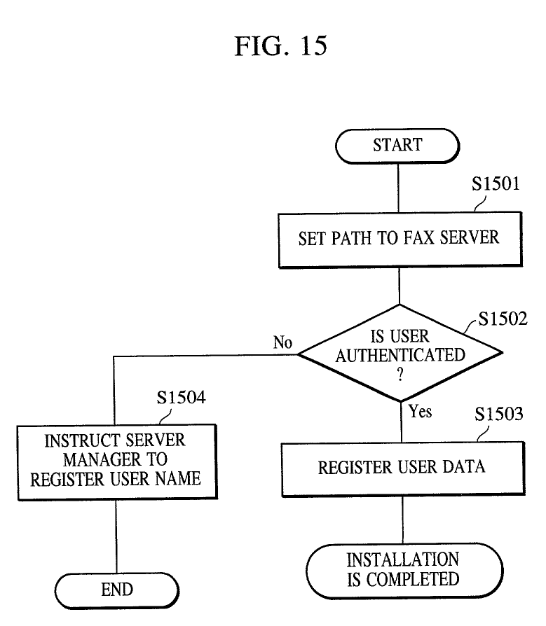

FIG. 15 is a flowchart showing a process of installing a fax driver in an HD 13(c) of the information processing apparatus of the fourth embodiment. Hereinafter it is assumed that a CPU 1 performs the process in accordance with a program stored in the HD 13(c).

Referring to FIG. 15, when the information processing apparatus is operated to give an instruction to install the fax driver, the installation of the fax driver begins. In step S1501, the process sets a path to the fax server F which performs user management of the facsimile machine on a network (LAN in FIG. 14). In step S1502, the process performs user authentication by determining whether a user who started the installation of the fax driver is a user under management of the fax driver F.

As the default, the process performs the authentication by using a log-on name for the fax server F and a password therefor. When the user is authenticated, the user is logged on to the fax server F. When the process determines, in step S1502, that the user of the information processing apparatus is not registered in the fax server F, the process instructs a server manager to register the user name, and the process is terminated.

When the user is verified as a user registered in the fax server F, the process registers user data in the fax server F in step S1503. The registration of user data includes registration of a sender name which is automatically written on a cover page, registration of a cover page (FIG. 23) which is created separately, registration of an address book, and registration of personal data concerning facsimile transmission. The user data is stored in a work space in the fax server F for each user. At the same time as the user is logged on to the fax server F, the process establishes a connection with the work space for the user, and hence it is possible to refer to the user data. Only an authenticated user who has established a connection can refer to and use the data stored in the work space for each user. When the registration in step S1503 is completed, the installation progresses, and the installation is performed until it is completed.

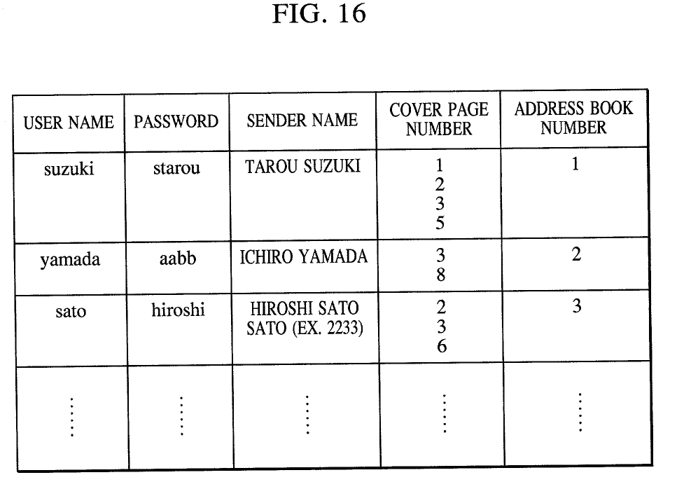

As shown in FIG. 16, the information registered in step S1503 is stored in a storage apparatus such as a hard disk of the fax server F, according to the user name and the password.

As in the third embodiment, a plurality of sender names can be registered in the fax server F under a single user name. Also, a plurality of cover pages and address books can be registered.

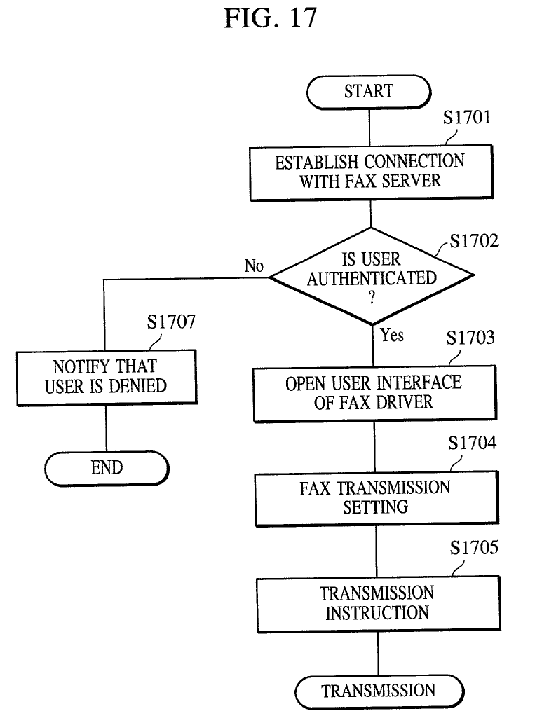

FIG. 17 is a flowchart showing a facsimile transmission process performed by the CPU 1 of the information processing apparatus of the fourth embodiment in accordance with the program stored in the HD 13(c).

Referring to FIG. 17, when a facsimile machine is specified as a device for outputting a document created by the user using the information processing apparatus, the fax driver is activated. When the fax driver is activated, in step S1701, the process establishes a connection with the fax server F along the path which is set when the fax driver is installed. In step S1702, the process performs user authentication for the use of the fax driver. The eligible user name and password are the user name and password which are registered and managed by the fax server F on the network. When the input user name and password do not match the registered user name and password, the process notifies the user in step S1707 that the user is not allowed to transmit a facsimile. The connection with the fax server F is broken, and the process is terminated. When the user is authenticated in step S1702, the process establishes a connection with a work space which stores data for each user. In step S1703, the process opens a user interface of the fax driver. Using various types of available data stored in the work space for each user, various settings such as the selection of a cover page, setting of a destination phone number, and inputting of information to a destination region H and a transmission message region J are performed. When a plurality of sender names which correspond to the user name is registered, the selection of a sender name is performed. These settings are transmitted from the information processing apparatus to the fax server F, and the fax server F creates a cover page based on these settings. When a facsimile transmission instruction is given in step S1705, the process transmits the document to the fax server F in step S1706. The fax server F writes the sender name which is stored corresponding to the user name used in the authentication in a sender name region I of the created cover page. The cover page is added to the top of the document transmitted from the information processing apparatus. The document and a destination fax number set by the information processing apparatus are transmitted to the facsimile machine G. The facsimile machine G makes a call to the destination fax number and transmits the document.

As in the first to third embodiments, the sender name can be written not only on the cover page but also on each page of the document. In this case, in step S1704, the process sets whether the sender name is written only on the cover page or on each page.

As described above, according to the fourth embodiment, data on the cover page and the like is stored in the fax server F, and the fax server F performs processing such as writing of the sender name on the cover page. Hence, it is possible to alleviate the computational burden on the information processing apparatus.

Fifth Embodiment

According to a fifth embodiment, a cover page is registered in an information processing apparatus, and a user can freely use the cover page. A sender name is registered in a fax server F.

The configuration of a network of the fifth embodiment is similar to that of the fourth embodiment (FIGS. 14, 24, and 25).

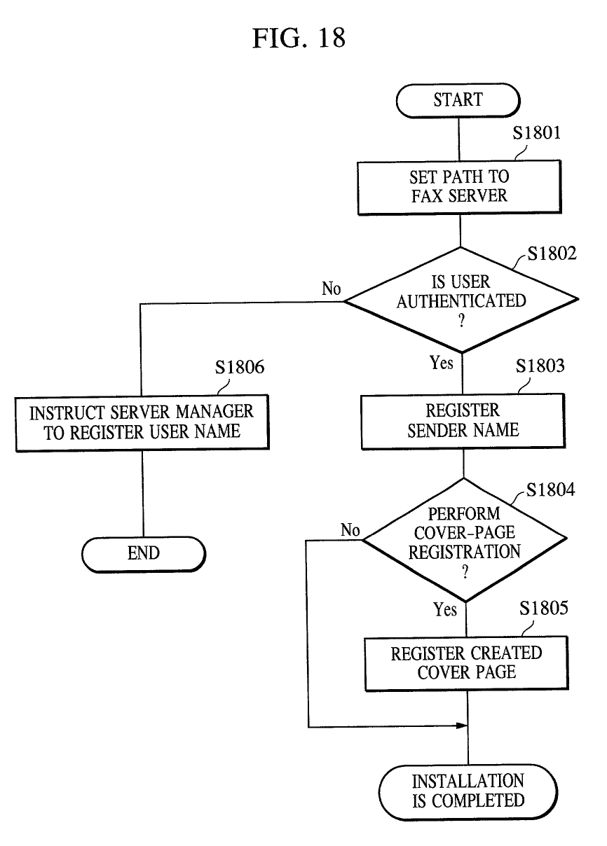

FIG. 18 is a flowchart showing a process of installing a fax driver in an HD 13(c) of the information processing apparatus of the fifth embodiment.

Referring to FIG. 18, when the information processing apparatus is operated to give an instruction to install the fax driver, the installation of the fax driver begins. In step S1801, the process sets a path to a fax server F which performs user management of a facsimile machine on the network (LAN in FIG. 14). In step S1802, the process performs user authentication by determining whether a user who began the installation of the fax driver is a user under management of the fax server F.

Since the authentication performed in step S1802 is similar to that performed in step S1502 in FIG. 15, a detailed description is omitted.

If it is determined in step S1802 that the user of the information processing apparatus is not registered in the fax server F, the process instructs a server manager to register the user in step S1806. The connection with the fax server F is broken, and the process is terminated.

When it is determined that the user is registered in the fax server F, the process registers a sender name, which is to be automatically registered on the cover page, in the fax server F in step S1803. In step S1804, the process determines whether to register a personal cover page of the user in the fax driver at the time the fax driver is installed, based on an instruction from the user. If the process determines to register a cover page, the process registers a cover page (FIG. 23) created by the user in step S1805 in the fax driver, and the installation is completed.

As in the third and fourth embodiments, a plurality of sender names can be registered in the fax server,F under a single user name.

In addition, a cover page and a sender name can be registered after the installation is completed.

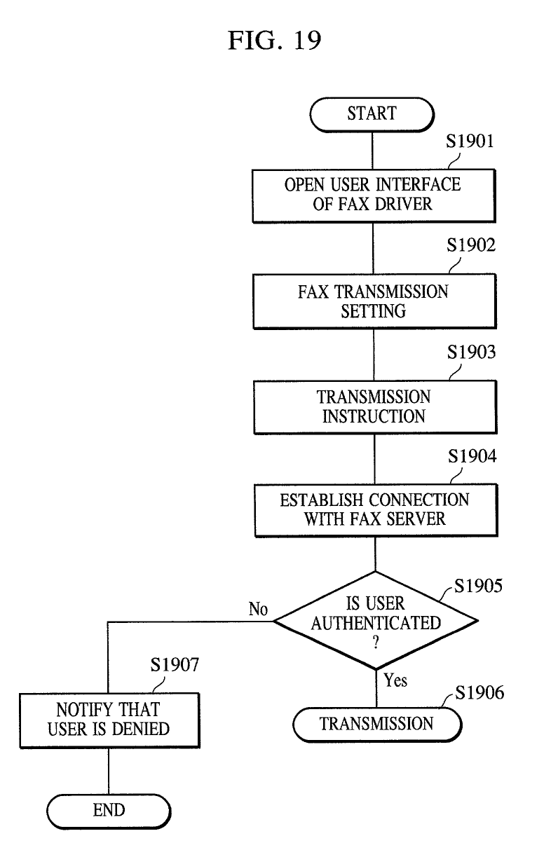

FIG. 19 is a flowchart showing a facsimile transmission process performed by the information processing apparatus of the fifth embodiment.

Referring to FIG. 19, when a facsimile machine is specified as a device for outputting a document created by the user using the information processing apparatus, the CPU 1 activates the fax driver. When the fax driver is activated, the process opens, in step S1901, a user interface of the fax driver, and hence various settings for facsimile transmission can be performed. In step S1902, the process performs facsimile transmission settings such as the selection of a cover page from among cover pages registered in the fax driver, inputting of information to a destination region H and a transmission message region J of the cover page, and specifying of a destination phone number. In step S1903, the process gives an instruction to transmit the document. In step S1904, in response to the transmission request, the process establishes a connection with the fax server F along the path which is set when the fax driver is installed. In step S1905, the process transmits the user name and password, which are input by the user in order that the fax server F can perform user authentication, to the fax server F. When the fax server F determines that the user is registered in the fax server F, in step S1906, the process adds the cover page selected in step S1902 to the top page of the document to be transmitted to the fax server F. The process transmits the document and the facsimile transmission setting information such as the destination phone number to the fax server F. When the process determines in step S1905 that the user is not registered in the fax server F, the fax server F notifies that the user is denied and cannot transmit a facsimile. In step S1907, the process notifies the user that the user is denied, and the process is terminated.

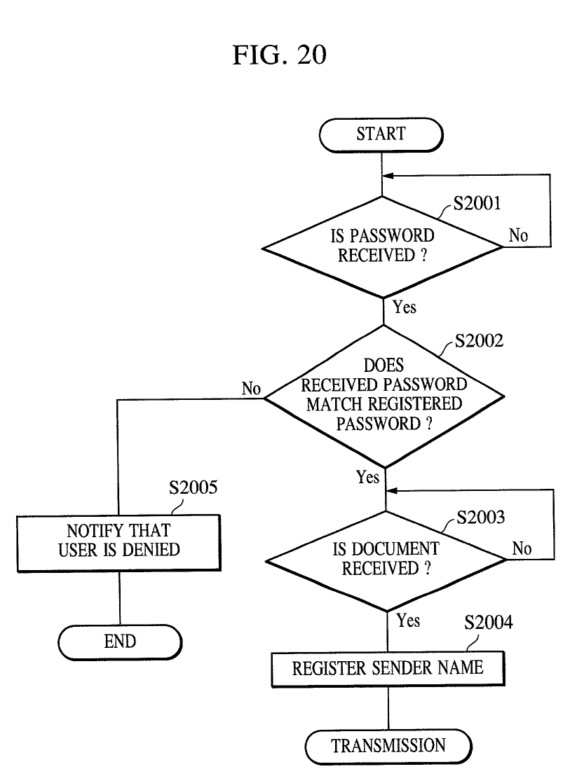

FIG. 20 is a flowchart showing a process performed by the fax server F.

Referring to FIG. 20, when a user name is transmitted from the information processing apparatus to the fax server F, the fax server F receives a password in step S2001. In step S2002, the fax server F determines whether the received password matches a password registered corresponding to the user name. If the determination is negative, the fax server F notifies the information processing apparatus that the user is denied and cannot transmit a facsimile.

When the received password matches the password registered corresponding to the user name, the fax server F notifies the information processing apparatus that the user can perform facsimile transmission. The fax server F receives a facsimile document to which the cover page is added from the fax driver. At the same time, the fax server F receives information such as a destination phone number to which the document is to be transmitted.

In step S2004, the fax server F writes a sender name, which is stored corresponding to the user name used in user authentication, in a sender name region I of the cover page added to the received document. The fax server F transmits the facsimile document and the information such as the destination phone number to a facsimile machine G.

The facsimile machine G makes a call to the phone number received with the document. Based on various facsimile transmission setting information received with the document, the facsimile machine G faxes the received document through a public telephone network.

As described above, according to the fifth embodiment, since the cover page is registered in the fax driver in the information processing apparatus, only a user of the information processing apparatus is authorized to use the cover page. Since a sender name is automatically written by the fax server F, the illicit use of a sender name for each user is prevented.

Sixth Embodiment

According to a sixth embodiment, it is possible to select user management using a fax driver installed in an information processing apparatus or user management using a fax server F on a network when the fax driver is installed.

In other words, the user management method can be selected in accordance with a network environment in which the information processing apparatus is connected.

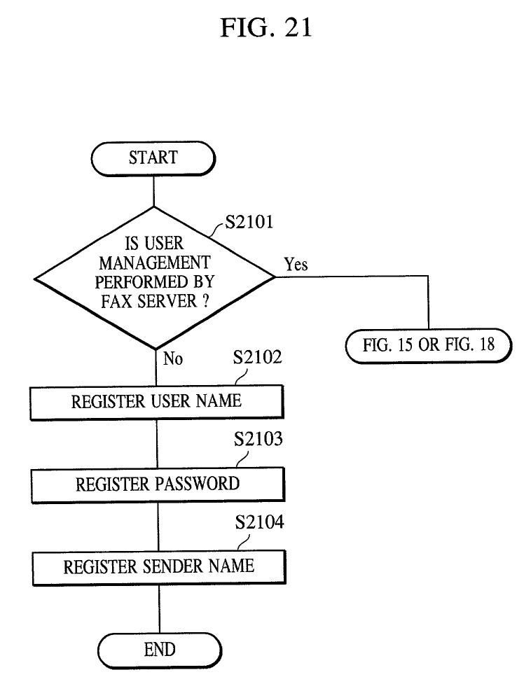

FIG. 21 is a flowchart showing a process of installing the fax driver in the information processing apparatus of the sixth embodiment.

Referring to FIG. 21, when the information processing apparatus is operated to give an instruction to install the fax driver, the installation of the fax driver begins. In step S2101, the process sets a user management method. The process can select the user management method from two types. One is a method for performing user management by registering a user in the fax server F on the network. The other method performs user management by registering a user in the fax driver of each information processing apparatus, instead of registering the user in the fax server F on the network. When user management is performed by each information processing apparatus, as in the first to third embodiments, user authentication can be performed using a log-on name for the information processing apparatus and a password therefor, or a network connection name and a password therefor.

When the process selects the user management using the fax server F, the process performs processing similar to that in the fourth or fifth embodiment, i.e., processing shown in FIG. 15 or FIG. 18.

When the process selects, in step S2101, the method for registering a user in the fax driver in the information processing apparatus, the process performs registration of a user name, password, and sender name in steps S2102 to 2104, respectively. The information is registered in the fax driver, and the installation of the fax driver is completed.

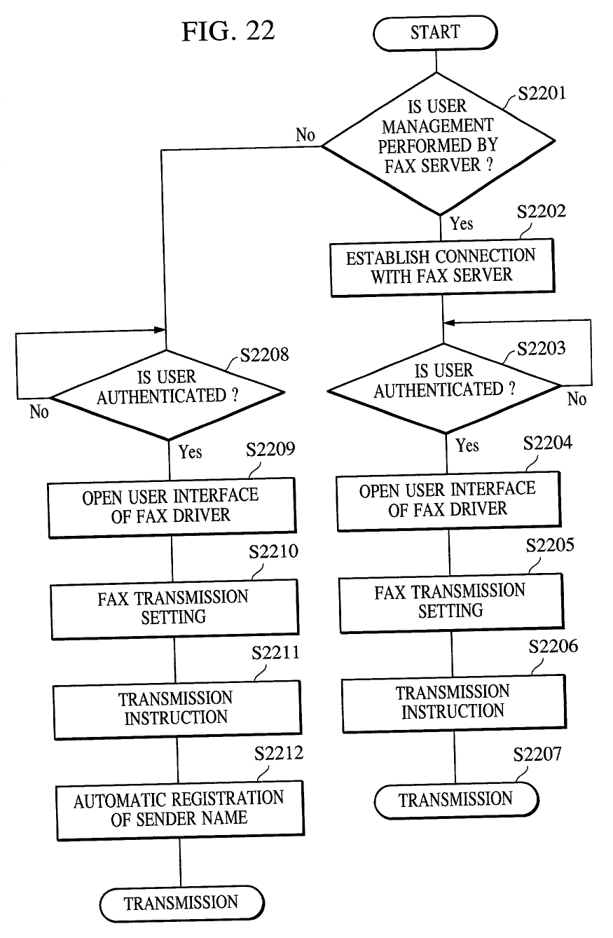

FIG. 22 is a flowchart showing a facsimile transmission process. When a facsimile machine is specified as a device for outputting a document created by the user, a CPU 1 of the information processing apparatus activates the fax driver. In step S2201, the process determines the user management method, which is set when the fax driver is installed. When the user management using the fax server F is performed, the process proceeds to step S2202. When the user management using the fax driver installed in the information processing apparatus is performed, the process proceeds to step S2208. In step S2202, the process establishes a connection with the fax server F along a path which is set when the fax driver is installed. In step S2203, the process performs user authentication. User authentication is performed by a user name and password which are registered in advance in the fax server F. When the user is not authenticated, the authentication is continuously performed by inputting a user name and password. When the user is authenticated as a registered user, the process establishes a connection with a work area for storing data for each user. In step S2204, the process opens a user interface of the fax driver, and hence various settings can be selected. In step S2205, facsimile transmission settings are selected. Specifically, a cover page is selected and pasted and a destination is set based on data registered in advance in the connected fax server F. In step S2206, the process gives an instruction to transmit the document. In step S2107, the process transmits the document to which the cover page is added to the fax server F. When the fax server F receives the document, the fax server F writes a sender name, which corresponds to the user name used in the user authentication, on the cover page or at a specified place on each page of the document. The fax server F transmits the document through the facsimile machine. When the process determines, in step S2201 that the user management is not performed by the fax server F, the process performs, in step S2208, user authentication for using the fax driver. The eligible user name and password are the user name and password registered by the process shown in FIG. 21. The password can be changed after the user is authenticated. When the user is not authenticated in step S2208, the process continuously performs the user authentication by inputting a user name and password. When the user is authenticated, the process opens the user interface of the fax driver in step S2209, and thereafter various settings may be selected and facsimile transmission can be performed. In step S2210, facsimile transmission settings are performed. Specifically, a cover page is selected and pasted, and a destination is set. In step S2211, the process gives an instruction to transmit the document. In step S2212, the process automatically writes a sender name, which corresponds to the user name used in the user authentication, on the cover page or at a specified place on each page of the document. In step S2213, the document in which the sender name is written is transmitted to the facsimile machine, and the facsimile machine actually transmits the document.

As described above, according to the sixth embodiment, it is possible to provide a fax driver capable of performing user management in accordance with a network environment.

Seventh Embodiment

According to a seventh embodiment, user authentication is performed and security is provided for a facsimile transmission system in which a fax server F on a network is capable of storing, editing, and retransmitting data. Since the system configuration is similar to that described in FIG. 14, detailed descriptions of common portions are omitted.

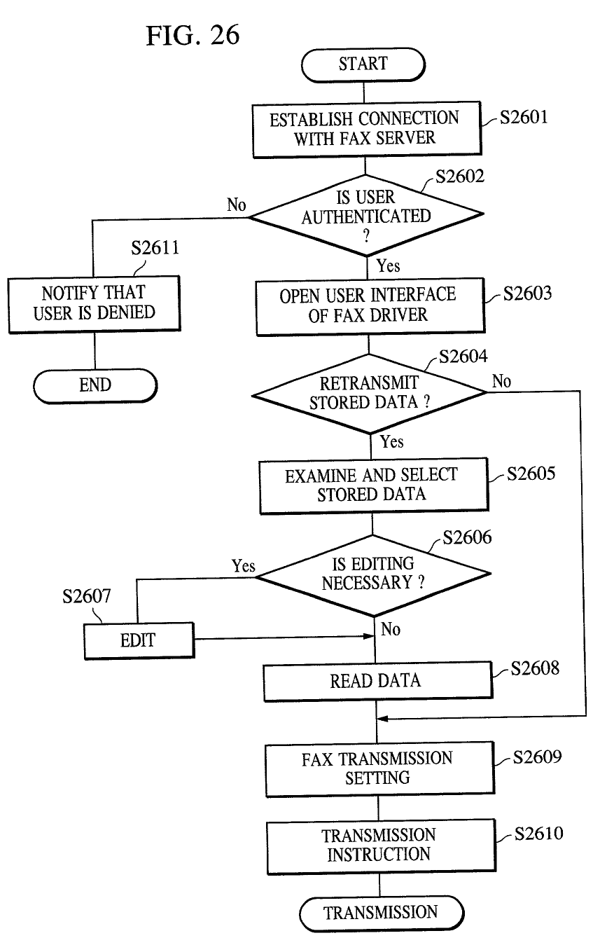

FIG. 26 is a facsimile transmission process performed by an information processing apparatus of the seventh embodiment.

Referring to FIG. 26, when a facsimile machine is specified as a device for outputting a document created by a user using the information processing apparatus, the process activates a fax driver. When the fax driver is activated, in step S2601, the process establishes a connection with the fax driver along a path which is set when the fax driver is installed. In step S2602, the fax driver requests user authentication for using the fax driver. The eligible user name and password are a user name and password registered and managed by a fax server F on the network. The fax driver transmits a user name and password input by the user to the fax server F, and the fax server F checks the input user name and password with the registered user name and password.

When the user name and password transmitted from the information processing apparatus match the user name and password registered in the fax server F, the fax server F notifies the information processing apparatus that the user is allowed to use the fax driver. In step S2602, when the fax server F does not notify the information processing apparatus that the user is allowed to use the fax driver or when the fax server F notifies that the user is denied, the information processing apparatus notifies, in step S2611, the user that the user is not allowed to perform facsimile transmission, and the process is terminated. When the fax server F notifies that the user is allowed to use the fax driver, the process logs on to the fax server F and establishes a connection with a work space for storing data for each user. In step S2603, the process opens a user interface of the fax driver, and hence various settings such as the selection of a cover page, setting of a destination phone number, and inputting of information to a destination region H and a transmission message region J can be performed. In step S2604, the process determines whether to retransmit data which is already stored in the fax server F. The data is stored in a transmission data storage area, which is prepared in addition to the work space for storing personal data.

It is possible to add, to the stored transmission data, data for setting a specific user who is permitted to edit and make reference to the stored transmission data. If the determination in step S2604 is affirmative, the process examines the stored data in step S2605. Specifically, the process examines the data which is already stored in the fax server F for data which can be referred to and be edited, and the process selects data to be retransmitted therefrom.

Of the transmission data stored in the fax server F, only data which is authorized to be referred to and be edited can be examined, selected, and edited in the work space for each user who logged on to the fax server F.

In step S2606, the process determines whether to edit the data selected for retransmission before sending. If the process determines not to edit the data, the process proceeds to step S2608. If the process determines to edit the data, the process edits the selected stored data in step S2607.

The edited transmission data can be stored as new data in the fax server F. Alternatively, it is possible to overwrite the stored data.

Only those who created the original transmission data stored in the fax server F can overwrite the data.

In step S2608, the process reads the data to be retransmitted from the fax server F. In step S2609, the process selects settings of information required for facsimile transmission, such as the selection of a cover page and specifying of a destination phone number. In step S2610, the process gives a facsimile transmission instruction. The process automatically inputs a sender name, which is registered corresponding to the user name used in the user authentication, in a sender name region I of the cover page. The process transmits the document to which the cover page is added to the fax server F or to the facsimile machine. The fax server F or the facsimile machine that has received the document transmits the document to a destination designated by the information processing apparatus. In the above description, the sender name is automatically input by the information processing apparatus. Alternatively, when the document is transmitted to the fax server F, the fax server F can automatically input the sender name.

As described above, according to the seventh embodiment, a facsimile document can be stored in the fax server F. It is also possible to edit the document and to transmit the edited document.

As described above, according to the present invention, it is possible to impose a restriction on the use of a shared communication apparatus.

It is also possible to add a sender name, which corresponds to a user name employed when authentication for using a fax driver or for establishing a connection with a fax server is performed, to a transmission document and to transmit the document. Thus, it is possible to prevent a person from posing as a different person when transmitting data such as a document.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. An information processing apparatus comprising:
authentication means for performing authentication using information which specifies a user of said information processing apparatus; and
transmitting means for automatically adding sender information which corresponds to the information that specifies a user, which is used in the authentication, to transmission data and transmitting the transmission data.

2. An information processing apparatus according to claim 1, wherein said transmitting means adds the sender information to a cover page of the transmission data.

3. An information processing apparatus according to claim 2, wherein the cover page is registered in advance in said information processing apparatus; and
said transmitting means automatically adds the cover page to the transmission data.

4. An information processing apparatus according to claim 3, wherein the use of the cover page which is registered in advance is restricted based on the information which specifies the user.

5. An information processing apparatus according to claim 1, further comprising:
connecting means for establishing a connection with a communication apparatus; and
storing means for storing a program for transmitting the transmission data using said communication apparatus;
wherein said authentication means performs the authentication in order to determine whether the user of said information processing apparatus is authorized to use the program.

6. An information processing apparatus according to claim 1, further comprising:
connecting means for establishing a connection with a communication apparatus;
wherein said authentication means performs the authentication in order to determine whether the user of said information processing apparatus is authorized to establish a connection with said communication apparatus.

7. An information processing apparatus according to claim 5, wherein said communication apparatus comprises a facsimile machine.

8. An information processing apparatus according to claim 6, wherein said communication apparatus comprises a facsimile machine.

9. An information processing apparatus according to claim 5, wherein said communication apparatus comprises a server on a network.

10. An information processing apparatus according to claim 6, wherein said communication apparatus comprises a server on a network.

11. An information processing apparatus comprising:
storing means for storing second information corresponding to first information, the first information specifying a user of another information processing apparatus;
receiving means for receiving the first information and transmission data transmitted from the other information processing apparatus; and
transmitting means for adding the second information corresponding to the first information received by said receiving means to the transmission data and transmitting the transmission data.

12. An information processing apparatus according to claim 11, wherein said transmitting means adds a cover page to the transmission data and thereafter transmits the transmission data.

13. An information processing apparatus according to claim 12, wherein said transmitting means adds the second information to the cover page.

14. An information processing apparatus according to claim 12, wherein said receiving means receives third information which specifies the cover page; and
said transmitting means adds the cover page specified by the third information to the transmission data.

15. An information processing apparatus comprising:
determining means for determining whether a user of said information processing apparatus is authorized to transmit data using a communication apparatus connected to said information processing apparatus; and
transmitting means for transmitting the data, which is to be transmitted from said communication apparatus, to said communication apparatus in accordance with the determination by said determining means.

16. An information processing apparatus according to claim 15, further comprising storing means for storing a program for transmitting data using said communication apparatus;
wherein said determining means determines whether the user of said information processing apparatus is authorized to use the program stored in said storing means; and
said transmitting means uses the program and transmits the data, which is to be transmitted from said communication apparatus, to said communication apparatus in accordance with the determination by said determining means.

17. An information processing apparatus according to claim 15, wherein said communication apparatus is connected through a management device for managing a network; and
said determining means performs the determination based on information from said management device.

18. A control method for an information processing apparatus, comprising the steps of:
performing authentication using information which specifies a user of said information processing apparatus; and
automatically adding sender information corresponding to the information specifying the user, which is used in the authentication, to transmission data and transmitting the transmission data.

19. A control method for an information processing apparatus, comprising the steps of:
storing second information corresponding to first information, the first information specifying a user of another information processing apparatus; and
adding, when the first information and transmission data transmitted from the other information processing apparatus are received, the second information corresponding to the received first information to the transmission data and transmitting the transmission data.

20. A control method for an information processing apparatus, comprising the steps of:
determining whether a user of said information processing apparatus is authorized to transmit data using a communication apparatus connected to the information processing apparatus; and
transmitting the data, which is to be transmitted from the communication apparatus, to the communication apparatus in accordance with the determination obtained in said determining step.

21. A computer-readable program for controlling an information processing apparatus, comprising:
an authentication step of performing authentication using information which specifies a user of said information processing apparatus; and
a transmitting step of automatically adding sender information corresponding to the information specifying the user of the information processing apparatus, which is used in the authentication, to transmission data and transmitting the transmission data.

22. A computer-readable program for controlling an information processing apparatus, comprising:
a storing step of storing second information corresponding to first information, the first information specifying a user of another information processing apparatus;
a receiving step of receiving the first information and transmission data transmitted from the other information processing apparatus; and
a transmitting step of adding the second information corresponding to the first information received in said receiving step to the transmission data and transmitting the transmission data.

23. A computer-readable program for controlling an information processing apparatus, comprising:
a determining step of determining whether a user of said information processing apparatus is authorized to transmit data using a communication apparatus connected to said information processing apparatus; and
a transmitting step of transmitting the data, which is to be transmitted from said communication apparatus, to said communication apparatus in accordance with the determination obtained in said determining step.
